(19) United States
(12) Patent Application Publication
(10) Pub. No.: US 2024/0190612 A1
(43) Pub. Date: Jun. 13, 2024

(54) SYSTEM AND METHOD FOR SECURING CONTAINERS

(71) Applicant: Home Depot Product Authority, LLC, Atlanta, GA (US)

(72) Inventors: Brent Christopher, Centennial, CO (US); Kenneth Freeman, Centennial, CO (US)

(21) Appl. No.: 18/079,196

(22) Filed: Dec. 12, 2022

(51) Int. Cl. B65D 21/02; B62B 1/04

(52) U.S. Cl. CPC B65D 21/0228; B62B 1/04; B65D 21/023; B65D 2255/20

(57) ABSTRACT

A system for securing a first container to a second container comprises an upper locking portion and a lower locking portion. A first protrusion of the upper locking portion abuts the second container and restricts movement of the second container in the locked position. A surface of a second body of the lower locking portion is configured to receive a force and to cause the lower locking portion to rotate about a second pivot to an unlocked position. The rotation of the lower locking portion to the unlocked position causes a second protrusion of the upper locking portion to abut a first body of the upper locking portion and cause the upper locking portion to rotate to an unlocked position. The rotation of the upper locking portion to the unlocked position causes the first protrusion to disengage from the second container.

### TECHNICAL FIELD

This disclosure generally relates to a system for interlocking multiple storage containers.

### BACKGROUND

Tool storage systems are commonly used by businesses and consumers to store and organize tools, spare parts, fasteners, and the like. Tool storage systems range from single cabinets with one storage receptacle to systems with multiple cabinets, each with multiple storage receptacles configured to meet a variety of needs.

### SUMMARY

In one embodiment, A system for securing a first container to a second container, the system includes an upper locking portion and a lower locking portion. The upper locking portion includes a first body having a first protrusion extending laterally from the first body towards a relative center of the first container; a first pivot structured to interface with a recess of the first container; and a first resilient member configured to bias the upper locking portion in a locked position. The lower locking portion includes a second body having a surface and a second protrusion extending substantially parallel to a side of the second container; a second pivot structured to pivotably couple the second body to the second container; and a second resilient member configured to bias the lower locking portion in a locked position. The first protrusion abuts the second container and restricts movement of the second container in the locked position, the surface of the second body is configured to receive a force and to cause the lower locking portion to rotate about the second pivot to an unlocked position, the rotation of the lower locking portion to the unlocked position causes the second protrusion to abut the first body and cause the upper locking portion to rotate to an unlocked position, and the rotation of the upper locking portion to the unlocked position causes the first protrusion to disengage from the second container.

In one embodiment, a method for securing a first container having an upper locking portion to a second container having a lower locking portion includes causing the upper locking portion to pivot from a locked position to an unlocked position; positioning a relative bottom of the second container substantially flush with a relative top of the first container; causing the upper locking portion to pivot to locked position; and applying a force to the lower locking portion to cause the lower locking portion to pivot from a locked position to an unlocked position, the force substantially perpendicular to and extending away from a plane defined by the substantially flush position of the first and second containers. In the locked position, the upper locking portion secures the second container to the first container, in the unlocked position, the upper locking portion does not interface with the second container, and the pivoting of the lower locking portion causes the lower locking portion to interface with the upper locking portion and to force the upper locking portion to pivot from the locked position to the unlocked position.

In one embodiment, a first container includes a first upper portion having an upper locking portion including a first pivot structured to interface with a container; and a first lower portion having a lower locking portion including a second pivot structured to interface with the container. The first pivot is sized and shaped to interface with a second lower portion of a second container, and the second pivot is sized and shaped to interface with a second upper portion of the second container

### BRIEF DESCRIPTION OF THE DRAWINGS

FIG. 1a is a perspective view of a first container having a system for interlocking containers.

FIG. 1b is a perspective view of a second container having a system for interlocking containers.

FIG. 1c is a perspective view of a third container having a system for interlocking containers.

FIG. 1d is a perspective view of the first, second, and third containers of FIGS. 1a-c.

FIG. 2a is a perspective view of an upper locking portion of the system of FIG. 1a.

FIG. 2b is a side perspective view of the upper locking portion of FIG. 2a.

FIG. 2c is a rear perspective view of the upper locking portion of FIG. 2a.

FIG. 2d is a rear view of the upper locking portion of FIG. 2a.

FIG. 3a is a side cross-sectional view of the upper locking portion of FIG. 2a.

FIG. 3b is a front cross-sectional view of the upper locking portion of FIG. 2a.

FIG. 3c is a side perspective view of the upper locking portion of FIG. 2a.

FIG. 3d is a front perspective view of the upper locking portion of FIG. 2a.

FIG. 4a is a perspective view of a lower locking portion of the system of FIG. 1a.

FIG. 4b is a bottom perspective view of the lower locking portion of FIG. 4a.

FIG. 4c is a front perspective view of the lower locking portion of FIG. 4a.

FIG. 5a is a side cross-sectional view of the lower locking portion of FIG. 4a.

FIG. 5b is a front cross-sectional view of the lower locking portion of FIG. 4a.

FIG. 6a is a front perspective view of the first, second, and third containers of FIGS. 1a-c stacked and secured using the system for interlocking containers.

FIG. 6b is a side cross-sectional view of an interaction between the upper locking portion of FIG. 1a and the lower locking portion of FIG. 4a.

FIG. 7a is a perspective view of a container having a system for interlocking containers.

FIG. 7b is a perspective view of the system for interlocking containers of FIG. 7b.

### DETAILED DESCRIPTION

The following disclosure of example systems and methods is not intended to limit the scope of the detailed description to the precise form or forms detailed herein. Instead, the following disclosure is intended to be illustrative so that others may follow its teachings.

Described herein are systems and methods for securing containers. The system may include, for example, a rotatable upper locking portion positioned on a relative top (or upper portion) of a container and a rotatable lower locking portion on a relative bottom (or lower portion) of the same container. The locking portions may interface with locking portions of another container (e.g., the upper locking portion of one container with the lower locking portion of another). Because both the upper locking portion and lower locking portion rotate about respective axes, the system is simultaneously more secure (e.g., due to multiple points of connection) and more ergonomic. For example, because rotation of the lower locking portion is sufficient to release the system and is also aligned with the action of picking up a container, a user is able to de-couple containers in a single motion.

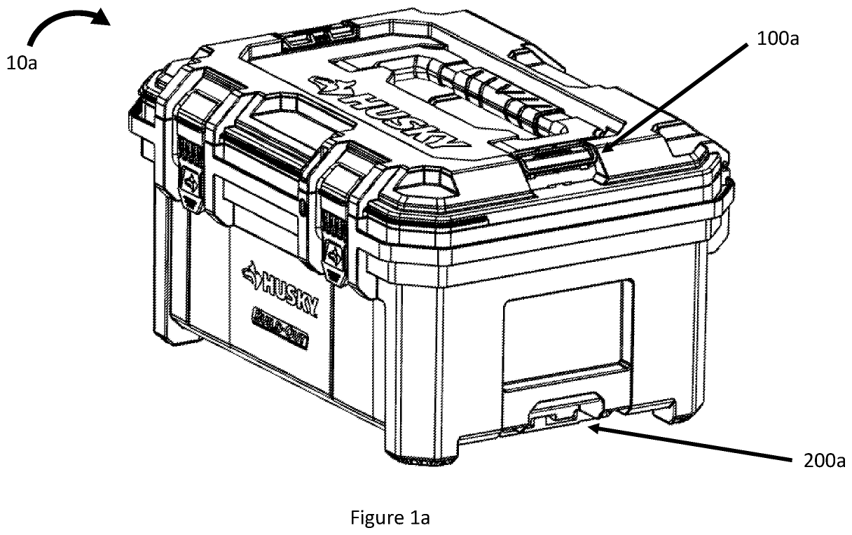

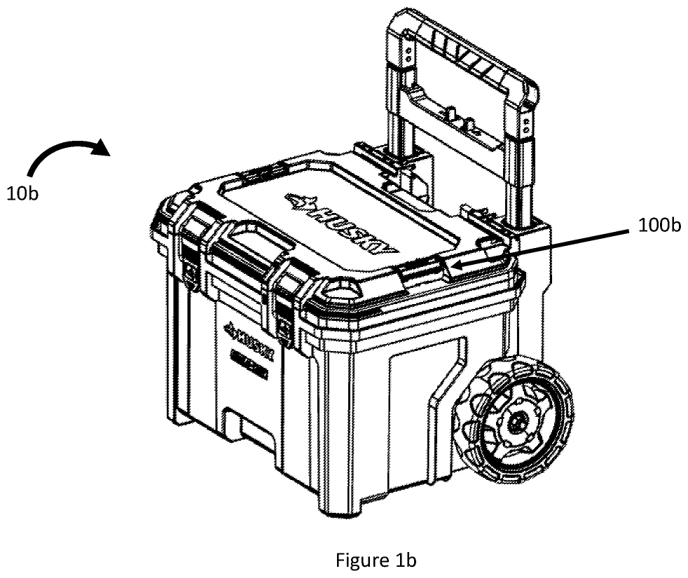

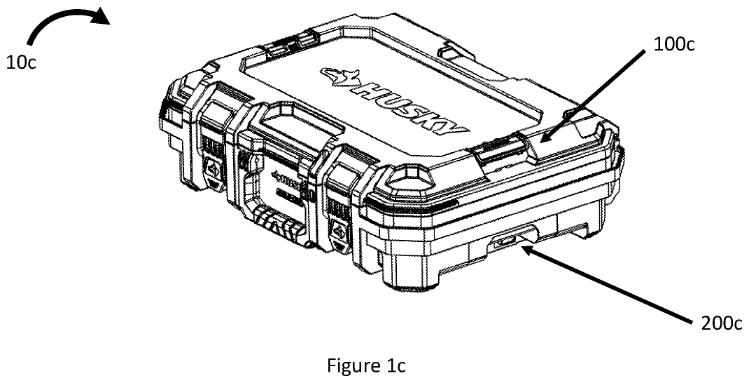

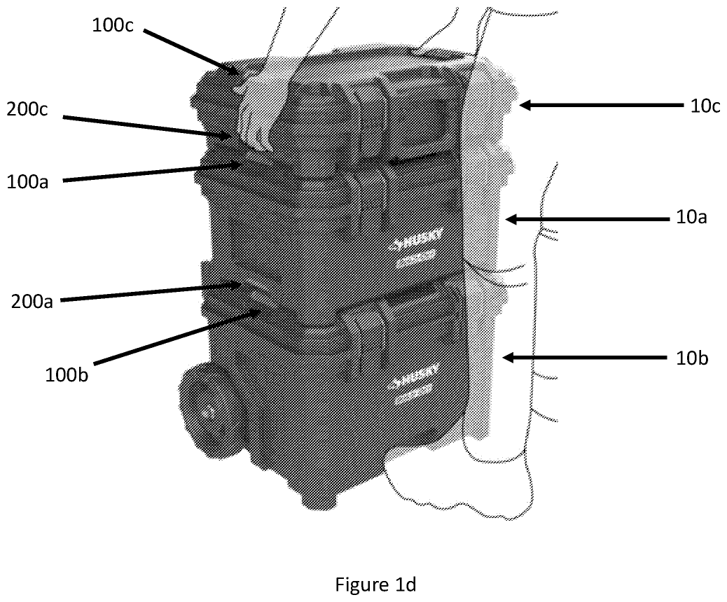

Referring to the drawings, wherein like numerals refer to the same or similar features in the various views, FIG. 1a is a perspective view of a first container having a system for interlocking containers, in accordance with various embodiments of the present disclosure. As shown in FIG. 1a, a first container 10a may include an upper portion having a first upper locking portion 100a and a lower portion having a first lower locking portion 200a. The upper portion (and, consequently, the first upper locking portion 100a) is located at a top (relative to the orientation shown in FIG. 1a) of the first container 10a and the lower portion (and, consequently, the first lower locking portion 200a) is located at a bottom (relative to the orientation shown in FIG. 1a) of the first container 10a.

FIG. 1b is a perspective view of a second container having a system for interlocking containers, in accordance with various embodiments of the present disclosure. As shown in FIG. 1b, a second container 10b may include a second upper locking portion 100b.

FIG. 1c is a perspective view of a third container having a system for interlocking containers, in accordance with various embodiments of the present disclosure. As shown in FIG. 1c, a third container 10c may include a third upper locking portion 100c and a third lower locking portion 200c.

FIG. 1d is a perspective view of the first, second, and third containers of FIGS. 1a-c, in accordance with various embodiments of the present disclosure.

As shown in FIGS. 1a-1d, upper locking portions 100a, 100b, and 100c are similar and may be collectively referred to as upper locking portion(s) 100. Similarly, lower locking portions 200a, 200b, and 200c are similar and may be collectively referred to as lower locking portion(s) 200. The first container 10a may be configured to couple with another container (e.g., the second container 10b of FIG. 1b, the third container 10c of FIG. 1c, etc.) below the first container 10a or above the first container 10a (relative to the orientation shown in FIG. 1a), or any other object having a corresponding upper locking portion 100 and/or lower locking portion 200. Although the locking portions are shown in use with containers, this disclosure should not be limited to only containers and should be understood to contemplate other objects (e.g., utility boxes, pallets, tables, etc.).

The upper locking portion 100 may be configured to interface with a lower locking portion 200 of another object (e.g., the second container 10b) to secure or lock the first container 10a to the other object, thereby enabling a user to securely stack containers.

FIG. 1d shows a perspective view of the first container 10a, the second container 10b, and the third container 10c securely stacked using the locking portions 100 and 200 of containers 10a-c. As shown in FIG. 1d, the second upper locking portion 100b may interface with the first lower locking portion 200a, and the first upper locking portion 100a may interface with the third lower locking portion 200c to interlock the second container 10b with the first container 10a and the first container 10a with the third container 10c, respectively. The interfacing of an upper locking portion 100 with a lower locking portion 200 secures the respective containers to each other.

As shown in FIG. 1d, the second upper locking portion 100b of the second container 10b is interfaced with the first lower locking portion 200a of the first container 10a. The first upper locking portion 100a of the first container 10a is interfaced with the third lower locking portion 200c of the third container 10c. The third upper locking portion 100c of the third container 10c may be configured to couple with another lower locking portion 200 of another object (e.g. another container). As shown in FIG. 1d, the upper locking portion 100 may be positioned under the lower locking portion 200 (relative to the orientation shown in FIG. 1d) when interfacing the locking portions of containers.

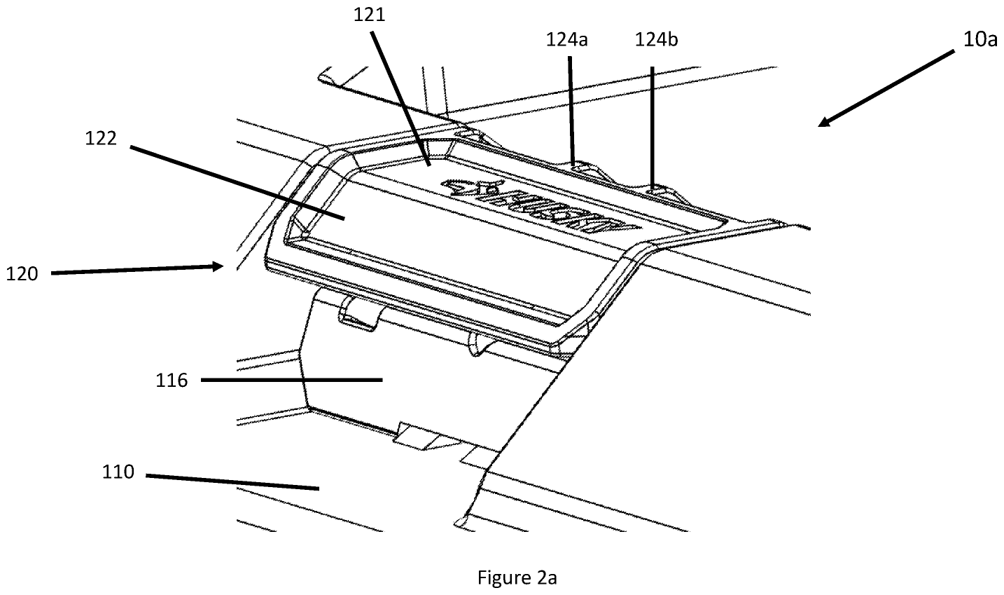

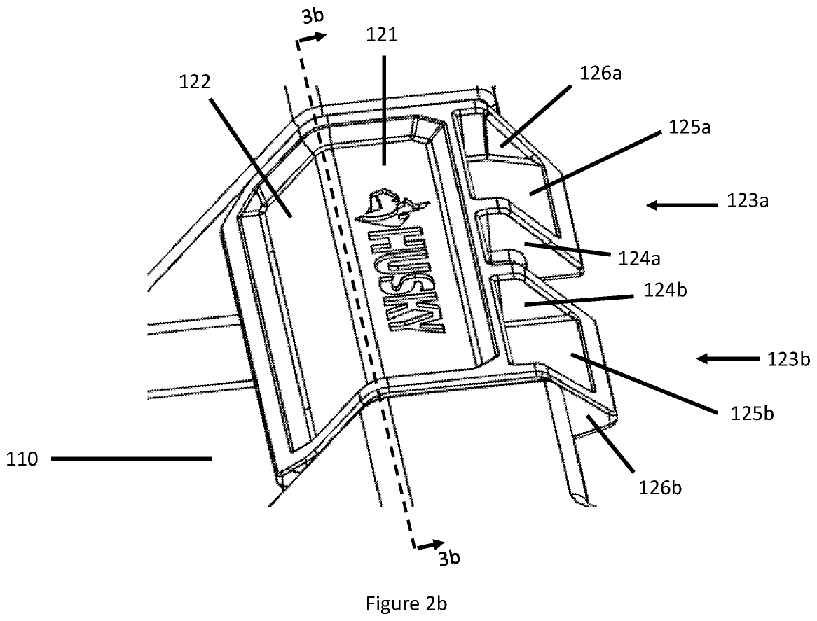

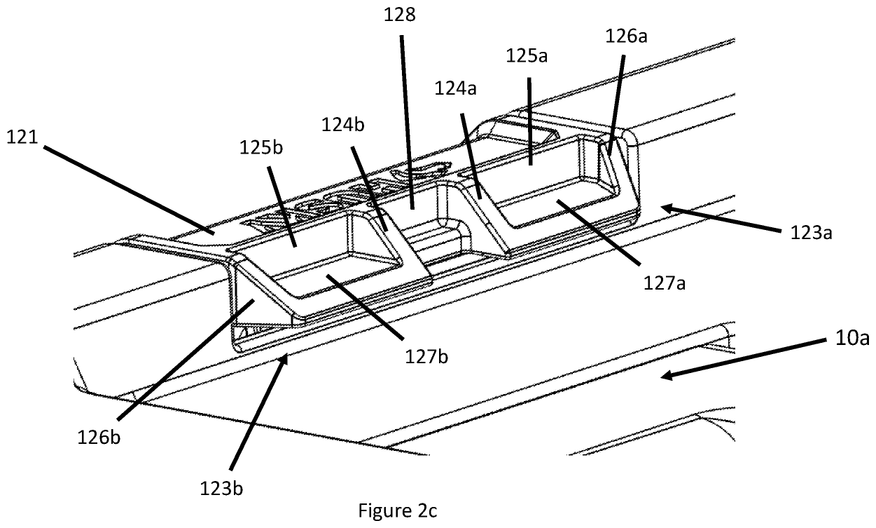

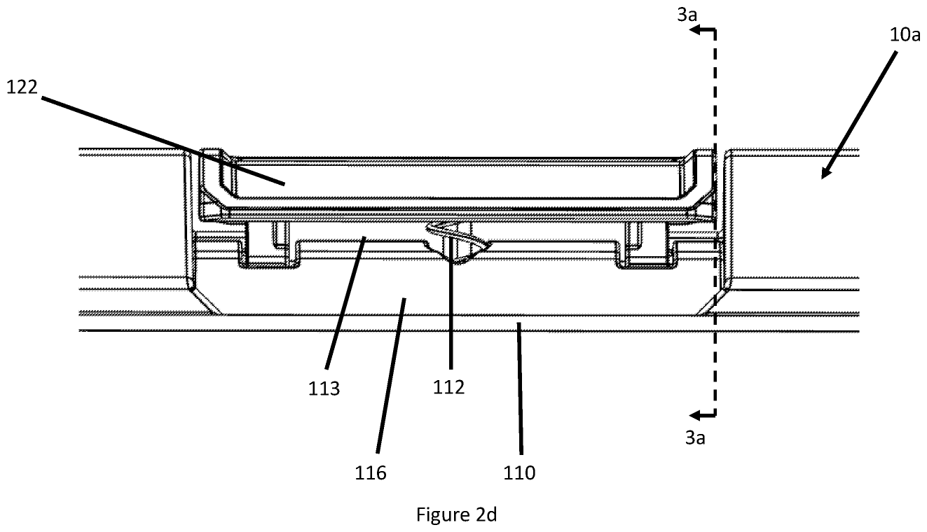

FIG. 2a is a perspective view of an upper locking portion of the system of FIG. 1a, in accordance with various embodiments of the present disclosure.

FIG. 2b is a side perspective view of the upper locking portion of FIG. 2a, in accordance with various embodiments of the present disclosure.

FIG. 2c is a rear perspective view of the upper locking portion of FIG. 2a, in accordance with various embodiments of the present disclosure.

FIG. 2d is a rear view of the upper locking portion of FIG. 2a, in accordance with various embodiments of the present disclosure.

As shown in FIGS. 2a-d the first upper locking portion 100a of the first container 10a is similar to the second upper locking portion 100b and the third upper locking portion 100c, and may be referred to as the upper locking portion(s) 100.

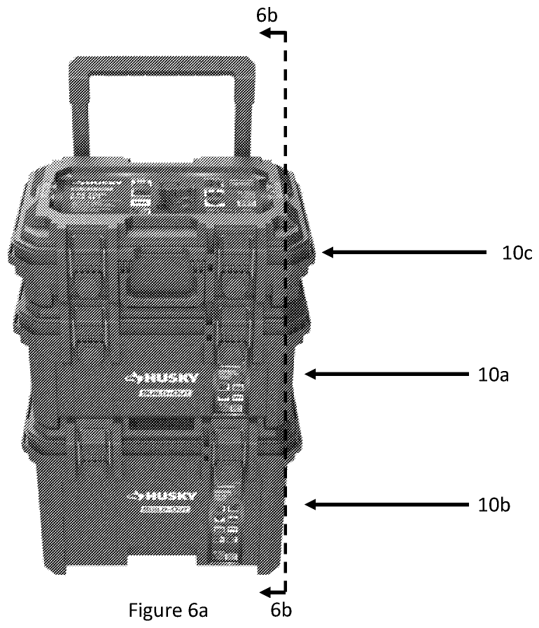

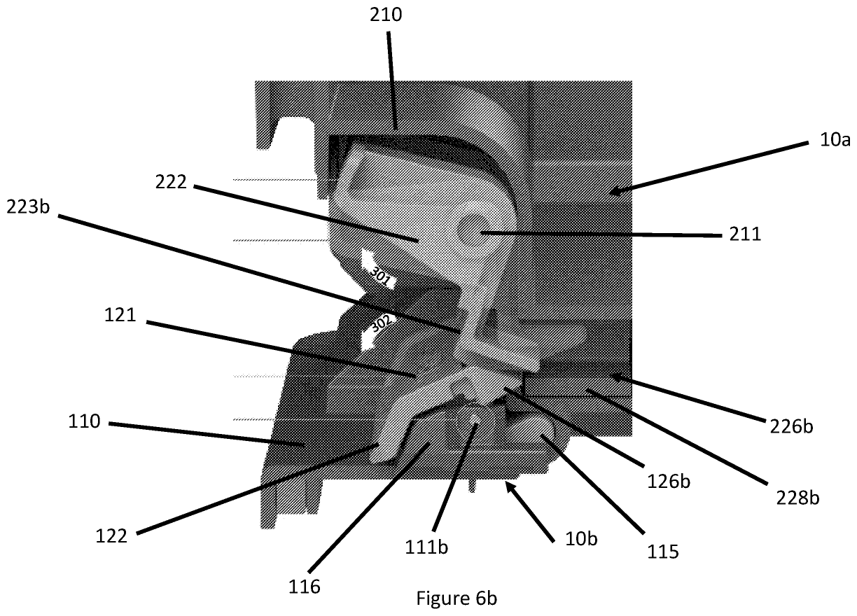

The upper locking portion 100 may include a first jaw 120 (e.g. a first body) and a first mounting base 110. The first jaw 120 may be structured to rotate relative to the first mounting base 110 in order to selectively interact with the container to which the upper locking portion 100 is securing (e.g., first container 10a to second container 10b). The first jaw 120 may include a rear protrusion 122, a first base plane 121, and a first upper tooth 123a and a second upper tooth 123b (collectively “the upper teeth 123”). The rear protrusion 122 and the upper teeth 123 may extend from opposite sides of the first base plane 121. The rear protrusion 122 may be structured to receive a user input while matching an overall silhouette of the upper locking portion 100, such that the rear protrusion 122 may extend diagonally down relative to the first base plane 121 to the outer edge of the first container 10a. The upper teeth 123 may be structured to interface directly with a portion of the other container to secure the other container to the first container 10a, which is described in greater depth below with reference to FIG. 6b. Accordingly, the upper teeth 123 may extend laterally relative to the first base plane 121 to the relative center of the first container 10a.

As shown in FIG. 2c, the first upper tooth 123a may include a first tooth back wall 125a, a first tooth side wall 124a, a second tooth side wall 126a, and a tooth base plane 127a. Tooth base plane 127a may extend laterally to the relative center of the container 10a. The first tooth back wall 125a may extend longitudinally from the tooth base plane 127a. The first tooth side wall 124a may extend laterally from one end of the first tooth back wall 125a and longitudinally from one end of the tooth base plane 127a. The edge of the first tooth side wall 124a may angle down, relative to the tooth base plane 127a, to the relative center of the first container 10a. The second tooth side wall 126a may extend laterally from one end of the first tooth back wall 125a, that end being opposite of the end from which the first tooth side wall 124a may extend. The second tooth side wall 126a may extend longitudinally from one end of the tooth base plane 127a, that end being opposite of the end from which the first tooth side wall 124a extends. The edge of the second tooth side wall 126a may angle down, relative to the tooth base plane 127a, to the relative center of the first container 10a.

As shown in FIG. 2c, the first tooth side wall 124a, the second tooth side wall 126a, the first tooth back wall 125a, and the tooth base plane 127a collectively form a cavity of the first upper tooth 123a which may be configured to receive a corresponding first lower tooth 223a of the lower locking portion 200. For example, when the lower locking portion 200 is rotated in order to decouple two containers, the first lower tooth 223a may be received by the cavity of the first upper tooth 123a, and the subsequent contact may cause the upper locking portion 100 to rotate, which is described in greater depth below with reference to FIG. 6b. The first upper tooth 123a and the second upper tooth 123b may be separated by an interior back wall 128. As shown in FIG. 2c, the second upper tooth 123b may be a mirror image of the first upper tooth 123a relative to the interior back wall 128. In some embodiments, the first jaw 120 may include a single tooth (e.g. a “first protrusion”) which couples with a single corresponding tooth of the lower locking portion 200. In some embodiments, the first jaw 120 may include multiple teeth (collectively, e,g, “a first protrusion”) which couple with the corresponding teeth from the lower locking portion 200.

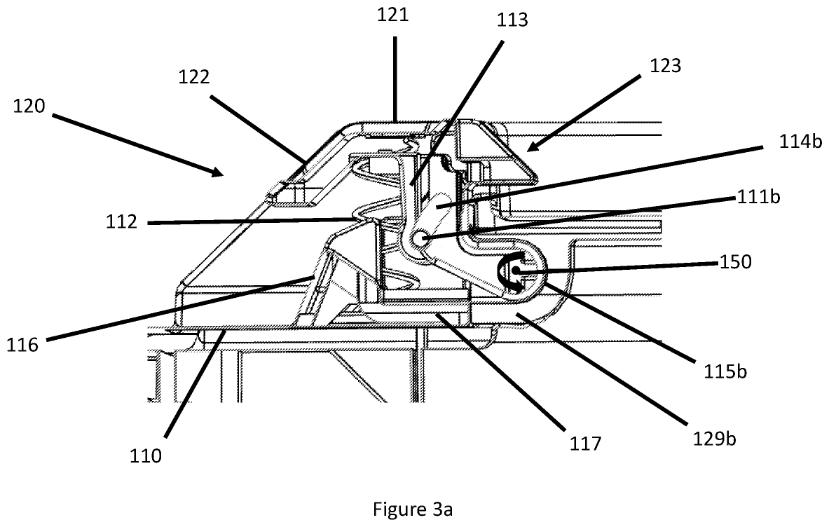

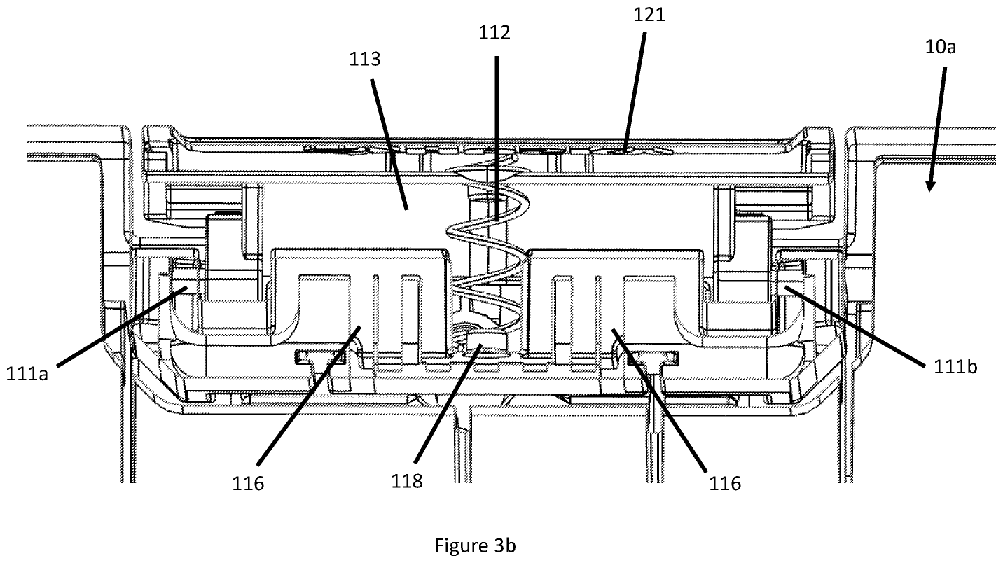

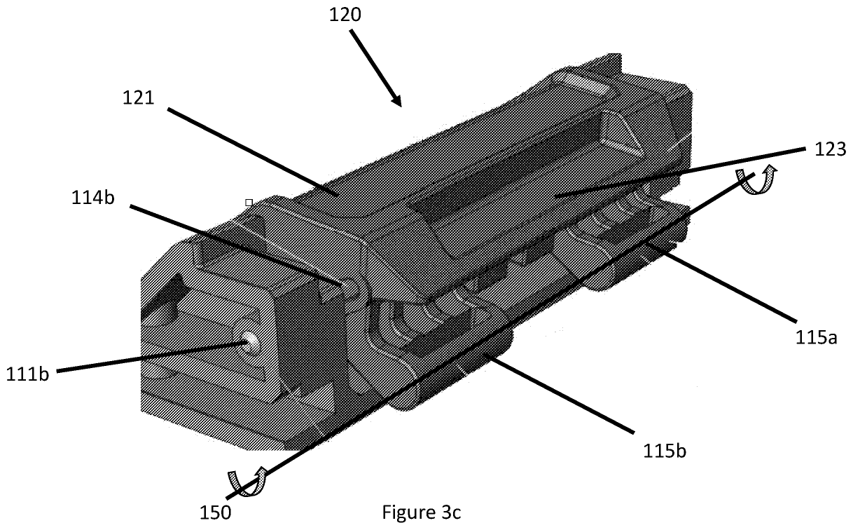

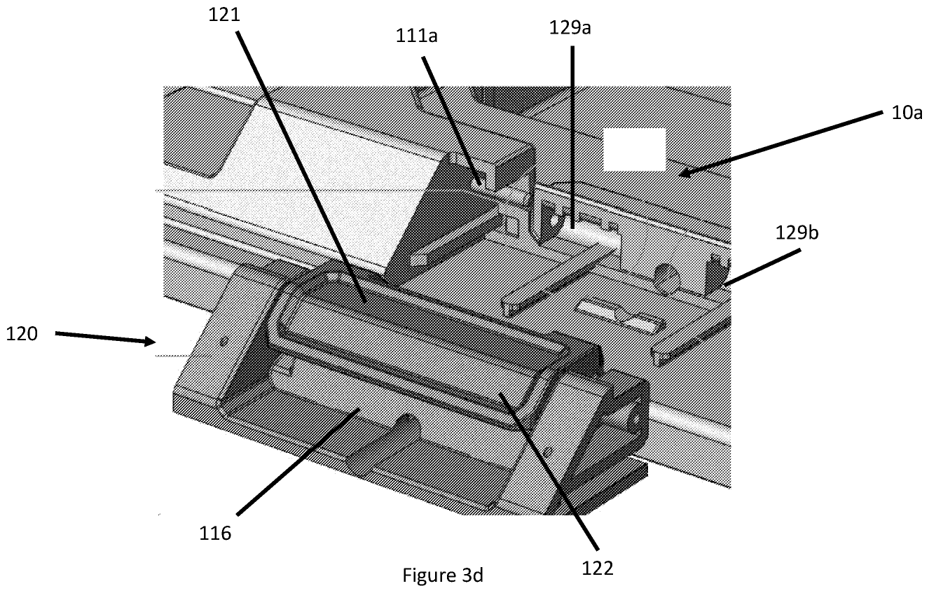

FIG. 3a is a side cross-sectional view of the upper locking portion of FIG. 2a taken along line 3a-3a in FIG. 2d, in accordance with various embodiments of the present disclosure.

FIG. 3b is a front cross-sectional view of the upper locking portion of FIG. 2a taken along line 3b-3b in FIG. 2b, in accordance with various embodiments of the present disclosure.

As shown in FIGS. 3a-b, the first jaw 120 maintains the shown position (e.g., a locking position) by a first resilient member 112 when not interfaced with a second jaw 220 of the lower locking portion 200. The first resilient member 112 may be connected on one end to a first base plane 121 of the first jaw 120 and on an opposite end to a first resilient member base 118 on a mounting plane 117. The first resilient member 112 may be configured to bias the first jaw 120 into a locking position while interfaced with the second jaw 220 of the lower locking portion 200 by providing an opposing force to the first base plane 121 when compressed due to a downward force exerted on the first jaw 120 (see FIG. 6b for more detail). This opposing force from the first resilient member 112 may maintain the shown position of the first jaw 120 by resisting the downward force caused by the first jaw 120 rotating counterclockwise (relative to the orientation shown in FIG. 3a). In some embodiments, the first resilient member 112 may be connected to any surface on the first jaw 120 and on an opposite end to a mounting plane of the upper locking portion. In some embodiments, the first resilient member 112 may be one of many resilient members configured to maintain the shown position (e.g., “locking position”) of the first jaw 120. In some embodiments, the first resilient member 112 can be of any tension which may be configured to maintain a desired position of the first jaw 120.

As shown in FIGS. 3a-b, the upper locking portion 100 may include a first jaw back wall 113. The first jaw back wall 113 may include a first arm 115a and a second arm 115b (collectively “arms 115” or e.g. a “first pivot”) which extend diagonally down relative to the first jaw back wall 113 towards the relative center of the first container 10a. The arms 115 may be received by a first cavity 129a and a second cavity 129b (collectively “cavities 129”) in the first container 10a. The cavities 129 (or recesses) are shown in greater depth in FIG. 3d. The arms 115 may be configured to rotate within the cavities 129, and this axis 150 of rotation may define the pivot point about which the entire upper locking portion turns. In some embodiments, the arms 115 are “floating” within the cavities 129, such that the arms 115 are able to freely rotate within the cavities 129 and are not coupled to the cavities 129. This floating design may enable the first locking portion 100 to be selectively coupled to the first container 10a, such that the first locking portion 100 may be removed or replaced (e.g., for maintenance) without otherwise altering or affecting the first container 10a. In other embodiments, a pin is included to extend from the first container 10a through the arms 115 to fix the axis 150 of rotation of the arms 115 within the cavities 129.

As shown in FIG. 3a, the upper locking portion 100 may further include a rear wall 116. The rear wall 116 may provide a limit for movement of the first jaw 120, such that as the first jaw 120 rotates about axis 150 defined by the arms 115 within the cavities 129, the rear protrusion 122 may contact the rear wall 116, which prevents further rotation. The arms 115, the first jaw back wall 113, and the first jaw 120 may be interconnected such that the first jaw back wall 113, and the first jaw 120 collectively rotate about the axis 150 to enable the first jaw 120 to rotate down relative to the shown position of the first container 10a so the rear protrusion 122 is proximate to the rear wall 116. This rotation also causes the upper teeth 123 to move laterally away from the relative center of the first container 10a, which effectively decouples the first container 10a from another container (as described below with reference to FIG. 6b).

The first jaw back wall 113 may extend longitudinally to a bottom (relative to the position shown in FIG. 3a) of the first container 10a. The first jaw back wall 113 may include a second groove 114b and a corresponding first groove 114a (not shown) (collectively “grooves 114”), that are shaped to follow an axis of rotation (e.g., about the arms 115) of the upper locking portion 100. The upper locking portion 100 may include a first upper pin 111a and a second upper pin 111b, (collectively “first pins 111”) that may extend from the first mounting base 110 to be coupled with the grooves 114, which guide the first jaw 120 to pivotably rotate with respect to the first mounting base 110. The first pins 111 may be fixed to the first mounting base 110, such that the first pins 111 move freely within the grooves 114. The grooves 114 may be structured to further define a range of movement for the first jaw 120, as the interaction of the first pins 111 with the grooves 114 prevents rotation of the first jaw 120 when the first pins 111 are at an end of the grooves 114.

As shown in FIG. 3a, the grooves 114 are curved with a relative top end proximate the upper teeth 123 and a relative bottom end proximate the arms 115. In the locked position shown in FIG. 3a, the second upper pin 111b is shown at the relative bottom of the second groove 114b. In an unlocked position (e.g., the resilient member 112 is compressed and the rear protrusion 122 is proximate the rear wall 116), the second upper pin 111b is at the relative top of the second groove 114b.

FIG. 3c is a side perspective view of the upper locking portion of FIG. 2a, in accordance with various embodiments of the present disclosure.

FIG. 3d is a front perspective view of the upper locking portion of FIG. 2a, in accordance with various embodiments of the present disclosure.

As shown in FIGS. 3c-d, the upper jaw 120 may include a single upper tooth 123. As such, it should be understood that upper jaw 120 may include any number of upper teeth 123. As shown in FIG. 3d, the upper locking portion 100 may be connected to the top (relative to the position shown in FIG. 3d) of first container 10a via the cavities 129. In particular, arms 115 of the upper locking portion 100 may be inserted into the cavities 129. Furthermore, FIGS. 3c-d illustrate that the upper locking portion may be selectively decoupled from the first container 10a, which enables removal or replacement of the upper locking portion 100 without altering or otherwise affecting the first container 10a.

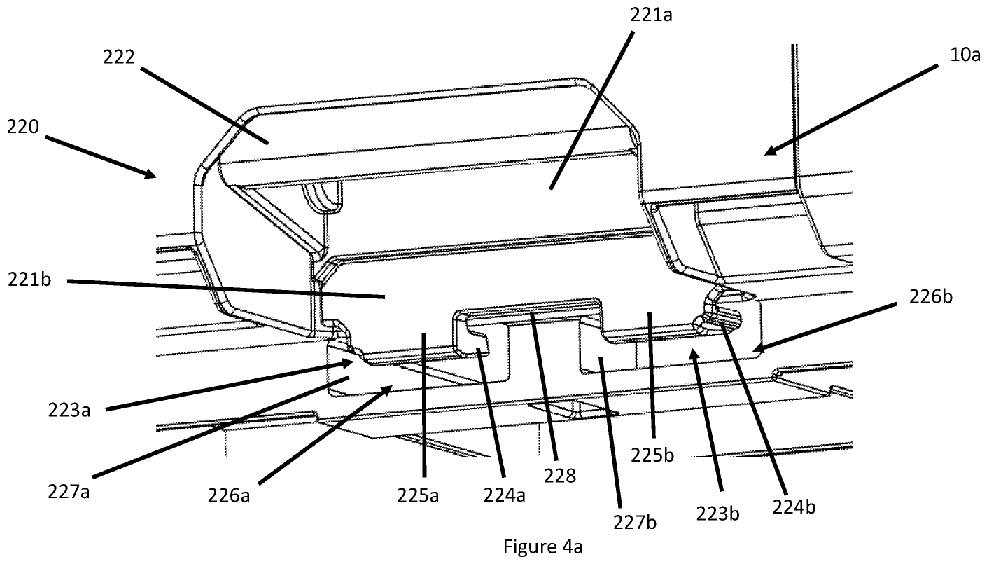

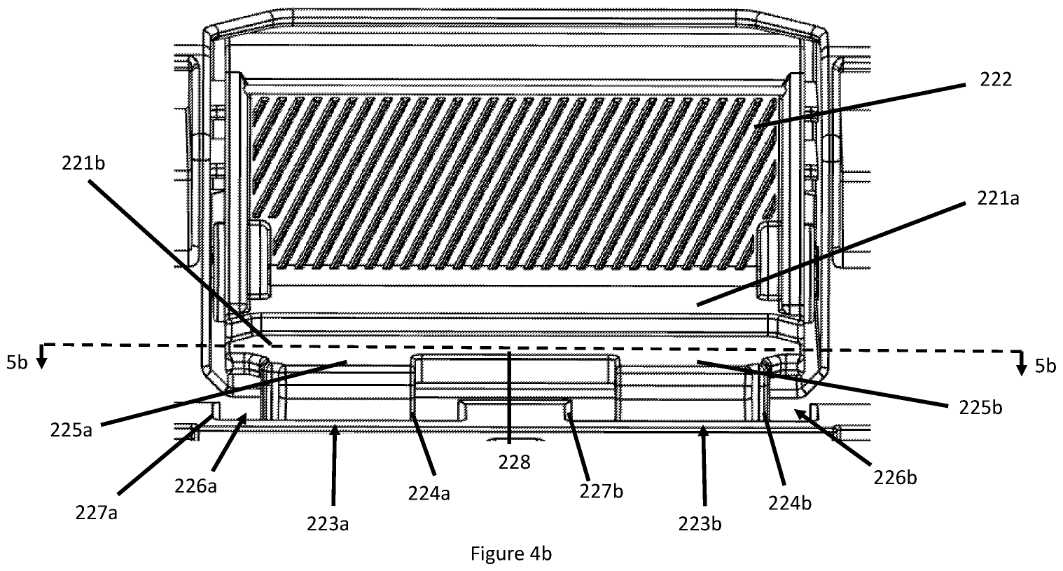

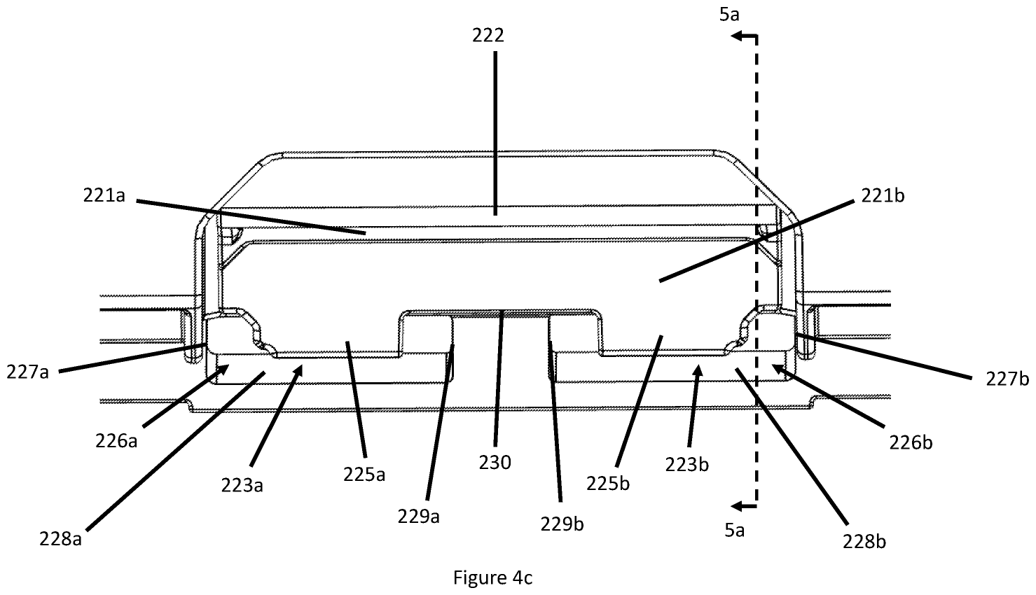

FIG. 4a is a perspective view of a lower locking portion of the system of FIG. 1a, in accordance with various embodiments of the present disclosure.

FIG. 4b is a bottom perspective view of the lower locking portion of FIG. 4a, in accordance with various embodiments of the present disclosure.

FIG. 4c is a front perspective view of the lower locking portion of FIG. 4a, in accordance with various embodiments of the present disclosure.

As shown in FIGS. 4a-c, the first lower locking portion 200a is similar to the second lower locking portion 200b and the third lower locking portion 200c, and may be referred to as the lower locking portion(s) 200. The lower locking portion 200 may include a second jaw 220 and a second mounting base 210. The second jaw 220 may include an upper back wall 221a and a lower back wall 221b (collectively “the second jaw back wall 221”), a surface 222, and a first lower tooth 223a and a second lower tooth 223b (collectively “lower teeth 223”). The first lower tooth 223a may protrude laterally to the relative center of the first container 10a inside a first cavity 226a of the first container 10a. The second lower tooth 223b may be configured to protrude laterally to the relative center of the first container 10a inside a second cavity 226b of the first container 10a. Although the lower teeth 223 are shown as relatively L-shaped, with a tooth front wall 225a extending relatively parallel to a side of the first container 10a and a tooth protrusion 224a extending laterally from the tooth front wall 225a to the relative center of the container 10a, it should be contemplated that the tooth protrusion 224a may be omitted, such that the lower teeth 223 extend only in parallel to the side of the first container 10a (e.g., the lower teeth 223 only include the tooth front wall 225a). As shown in FIG. 4a-c, the second lower tooth 223b may be a mirror image of the first lower tooth 223a relative to a ridge 230. The first cavity 226a and the second cavity 226b (collectively “cavities 226”) are shaped to couple with teeth 123 of the upper locking portion, which is shown in greater depth in FIG. 6b.

As shown in FIGS. 4a-c, the first cavity 226a may include a first cavity side wall 227a, a second cavity side wall 229a, and a first cavity base plane 228a. The first cavity base plane 228a may extend laterally to the relative center of the first container 10a. The first cavity side wall 227a may extend longitudinally from the first cavity base plane 228a. The second cavity side wall 229a may extend longitudinally from one end of the first cavity base plane 228a, that end being opposite of the end from which the first cavity side wall 227a extends.

As shown in FIG. 4c, the first cavity side wall 227a, the second cavity side wall 229a, and the first cavity base plane 228a collectively form the first cavity 226a which may be configured to couple with the corresponding first upper tooth 123a of the upper locking portion 100. The first cavity 226a and the second cavity 226b are separated by the ridge 230. As shown in FIG. 4c, the first cavity 226a may be a mirror image of the second cavity 226b relative to the ridge 230. The first cavity base plane 228a and the second cavity base plane 228b (collectively “cavity base planes 228”) may be configured to couple with the corresponding upper teeth 123 from the upper locking portion 100.

As shown in FIGS. 4a-c, the second jaw back wall 221 may extend longitudinally down to the bottom (relative to the position shown in FIG. 4c) of the first container 10a. The surface 222 may extend laterally from the second jaw back wall 221 to the outer edge of the first container 10a. As shown in FIG. 4a-c, the surface 222 is shaped to enable a user to place their hand when gripping the lower locking portion 200. The surface 222 may be textured (as shown in FIG. 4b) to provide an improved grip.

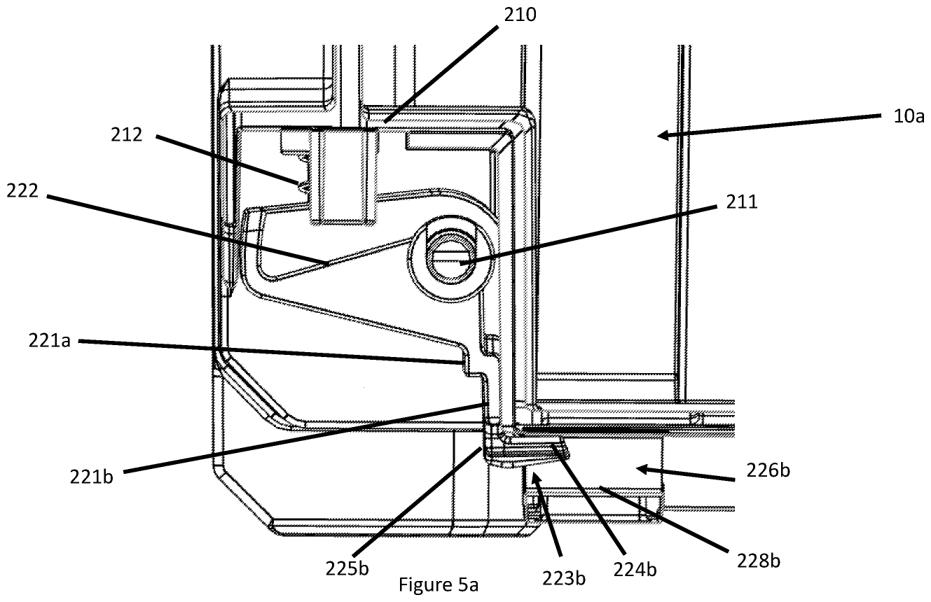

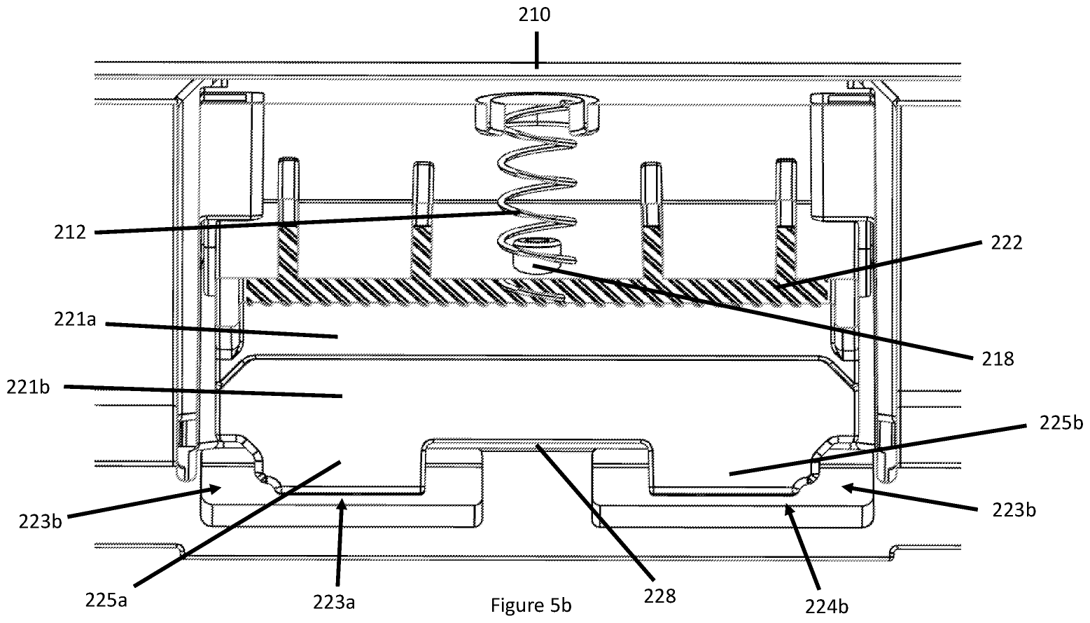

FIG. 5a is a side cross-sectional view of the lower locking portion of FIG. 4a taken along line 5a-5a in FIG. 4c, in accordance with various embodiments of the present disclosure.

FIG. 5b is a front cross-sectional view of the lower locking portion of FIG. 4a taken along line 5b-5b in FIG. 4b, in accordance with various embodiments of the present disclosure.

The second jaw 220 may maintain the position shown in FIGS. 5a-b (when not interfacing with the first jaw 120 of the first locking portion 100) by a second resilient member 212. The second resilient member 212 may be connected on one end to a second resilient member base 218 of the second jaw 220 and on an opposite end to a second mounting base 210. The second resilient member 212 may be configured to bias the second jaw 220 into a locking position while interfaced with the first jaw 120 of the first locking portion 100 by providing an opposing force to the second jaw 220 via the second resilient member base 218 when compressed due to an upward force exerted on the second jaw 220 (see FIG. 5b for more detail). This opposing force from the second resilient member 212 may maintain the shown position (e.g., a “locking” position) of the second jaw 220 by resisting the upward force. In some embodiments, the second resilient member 212 may be connected to any surface on the second jaw 220 and on an opposite end to a mounting plane of the lower locking portion. In some embodiments, the second resilient member 212 may be one of many resilient members configured to maintain the shown position of second jaw 220. In some embodiments, the second resilient member 212 can be of any tension which may be configured to maintain a desired position of second jaw 220.

As shown in FIG. 5a, the lower locking portion 200 may include a second pin 211 (e.g. a “second pivot”) which may extend laterally across the second jaw back wall 221 of the second jaw 220 to enable the second jaw 220 to rotate with respect to the second mounting base 210. The second jaw back wall 221 may house the second pin 211. The second pin 211 may be configured to rotate within the housing of the second jaw back wall 221 to enable the second jaw 220 to pivotably rotate with respect to the second mounting base 210. The second jaw 220 may be configured to pivotably rotate about the second pin 211 to enable the second jaw 220 to rotate up (relative to the second jaw back wall 221) so that the surface 222 is proximate to the second mounting base 210. The second locking portion 200 may be configured such that the lower teeth 223 slide out of the cavities 224 to the outer edge of the first container 10a when the second jaw 220 rotates about the second pin 211.

FIG. 6a shows a prospective view of the first container 10a, second container 10b, and third container 10c securely stacked using the locking portions 100 and 200 of containers 10a-c.

FIG. 6a is a front perspective view of the first, second, and third containers of FIGS. 1a-c stacked and secured using the system for interlocking containers, in accordance with various embodiments of the present disclosure.

FIG. 6b is a side cross-sectional view of an intersection between the upper locking portion of FIG. 1a and the lower locking portion of FIG. 4a taken along line 6b-6b in FIG. 6a, in accordance with various embodiments of the present disclosure.

As shown in FIG. 6b, the upper locking portion 100 of the second container 10b and the lower locking portion 200 of the first container 10a may interact to selectively secure the first container 10a to the second container 10b. The upper locking portion 100 may couple with the lower locking portion 200 as the containers are stacked, relative to the position shown in FIG. 6b. When the first container 10a is initially placed on the second container 10b, the second cavity base plane 228b applies a force to the slanted surface of the upper teeth 123, which is translated to rotational movement of the first jaw 120 about the arms 115. This force causes the first jaw 120 to rotate counter-clockwise (relative to the orientation of FIG. 6b), and causes the upper teeth 123 to move relatively away from the first container 10a. Once the first container 10a is positioned in place (e.g., a relative bottom of the first container 10a is flush with a top of the second container 10b), the second cavity base plane 228b is no longer applying force to the upper teeth 123, and the first resilient member 112 causes the first jaw 120 to return to the locked position, which causes the upper teeth 123 to enter the cavities 228. The interaction between the upper teeth 123 and the second cavity base plane 228b (e.g., the upper teeth 123 abutting the first container 10a) secures the first container 10a in place relative to the second container 10b.

As shown in FIG. 6b, a user may apply pressure to the surface 222 of the lower locking portion 200 as indicated by arrow 301, causing the second jaw 220 to rotate clockwise (relative to the orientation of FIG. 6b) about the second pin 211. As the second pin 211 rotates within the housing of the second jaw back wall 221, the lower teeth 223 rotate to the outer edge of the containers and make contact with or abut the upper teeth 123 (e.g., the first tooth back wall 125a and a second tooth back wall 125b, collectively teeth back walls 125) of the first jaw 120. This contact causes the first jaw 120 to rotate counter-clockwise (relative to the orientation of FIG. 6b) as indicated by arrow 302 to the outer edge of the second container 10b. The upper teeth 123 are then disengaged from the cavities 228, such that the upper teeth 123 are no longer abutting or applying a securing force to the first container 10a. After the upper locking portion 100 and the lower locking portion 200 are disengaged and the second container 10b and the first container 10a are respectively decoupled, the upper locking portion 100 returns to the maintained (e.g., locked) position shown in FIGS. 2a-d. The lower locking portion 200 returns to the maintained (e.g., locked) position shown in FIG. 4a-c.

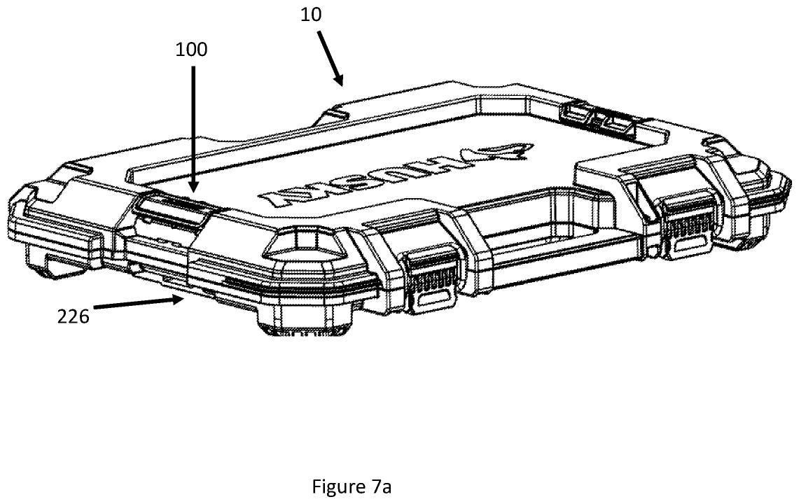

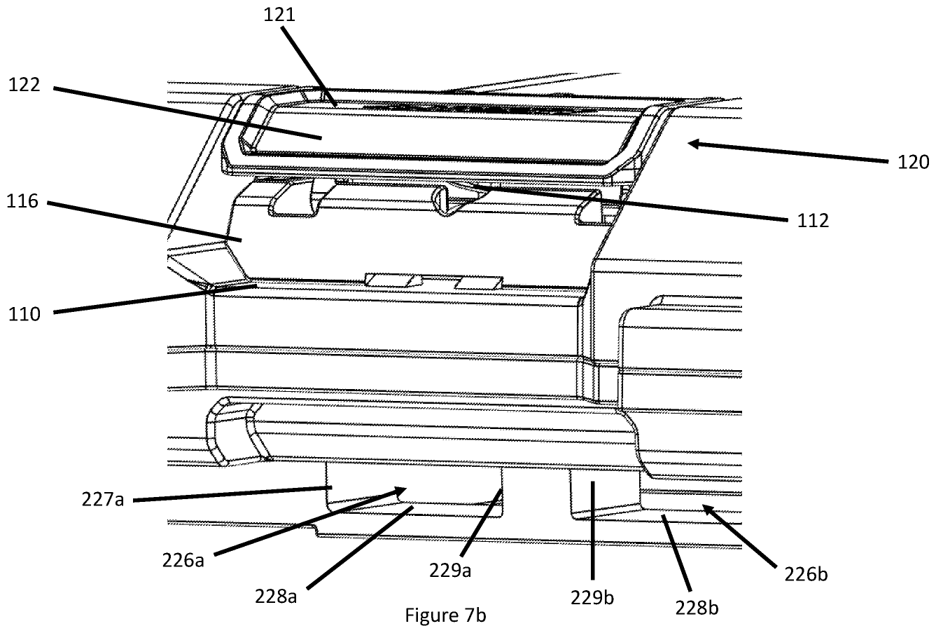

In some embodiments, the system for interlocking containers may omit the lower locking portion 200, such that the upper locking portion 100 may selectively secure the two containers together without interaction with the lower locking portion 200. FIG. 7a is a perspective view of a container having only the upper locking portion 100, in accordance with various embodiments of the present disclosure. FIG. 7b is a perspective view of an upper locking portion 100 of the system of FIG. 7a, in accordance with various embodiments of the present disclosure.

As shown in FIG. 7b, the upper locking portion 100 is identical to the upper locking portion 100 described with reference to FIGS. 3a-d. Similarly, the first and second cavities 228a-b are identical to the first and second cavities 228a-b described with reference to FIG. 6b, such that the upper locking portion 100 of a bottom container (e.g., first container 10a) interacts with the first and second cavities 228a-b of a top container (e.g., third container 10c) to secure the two containers together. The primary difference in these embodiments in which the lower locking portion 200 is omitted may be found in the decoupling process. As described with reference to FIG. 6b, the two secured containers may be decoupled by applying a force (indicated by arrow 301) relatively upwards onto the lower locking portion 200, which causes the lower locking portion 200 to rotate. This rotation applies a rotational force onto the upper locking portion 100 (as indicated by arrow 302), which causes the upper locking portion 100 to rotate outwards and disengage from the cavities 228. In those embodiments in which the lower locking portion 200 is omitted, the application of force indicated by arrow 301 is skipped, such that the rotational force is applied directly to the upper locking portion 100 along arrow 302, rather than being translated from force applied to the lower locking portion 200.

By omitting the lower locking portion 200, the number of moving parts in the system may be reduced, such that the chances of mechanical failure are lowered. Furthermore, removing the lower locking portion 200 saves space on the container, such that the container may maintain a smaller side profile and/or height. An example of this smaller container is shown in FIG. 7a, which may be compared to the example containers illustrated in FIGS. 1a-d.

Although certain example systems and methods have been described herein, the scope of coverage of this patent is not limited thereto. On the contrary, this patent covers all systems, methods, apparatus, and articles of manufacture fairly falling within the scope of the appended claims either literally or under the doctrine of equivalents.

What is claimed is:

1. A system for securing a first container to a second container, the system comprising:
an upper locking portion comprising:
a first body having a first protrusion extending laterally from the first body towards a relative center of the first container;
a first pivot structured to interface with a recess of the first container; and
a first resilient member configured to bias the upper locking portion in a locked position; and
a lower locking portion comprising:
a second body having a surface and a second protrusion extending substantially parallel to a side of the second container;
a second pivot structured to pivotably couple the second body to the second container; and
a second resilient member configured to bias the lower locking portion in a locked position; and
wherein:
the first protrusion abuts the second container and restricts movement of the second container in the locked position,
the surface of the second body is configured to receive a force and to cause the lower locking portion to rotate about the second pivot to an unlocked position,
the rotation of the lower locking portion to the unlocked position causes the second protrusion to abut the first body and cause the upper locking portion to rotate to an unlocked position, and
the rotation of the upper locking portion to the unlocked position causes the first protrusion to disengage from the second container.

2. The system of claim 1, wherein the first pivot is not fixed to the recess.

3. The system of claim 1, wherein the upper locking portion further comprises:
a groove positioned in a side of the first body, the groove curved about an axis of rotation defined by the first pivot; and
a pin extending from the first container into the groove.

4. The system of claim 3, wherein the pin interacting with a first end of the groove defines the locked position, and the pin interacting with a second end of the groove defines the unlocked position.

5. The system of claim 1, wherein:
the upper locking portion is positioned on a relative top of the first container, and
the lower locking portion is positioned on a relative bottom of the second container.

6. The system of claim 1, wherein the resilient member comprises a spring.

7. The system of claim 6, wherein:
the upper locking portion is a first upper locking portion and the lower locking portion is a second lower locking portion,
the first container further comprises a first lower locking portion positioned on a relative bottom of the first container, the first lower locking portion identical to the second lower locking portion, and
the second container further comprises a second upper locking portion positioned on a relative top of the second container, the second upper locking portion identical to the first upper locking portion.

8. The system of claim 1, wherein:
in response to the second container being placed on a relative top of the first container, the second container interfaces with the upper locking portion and forces the upper locking portion into the unlocked position, and
in response to the second container being positioned in substantially flush contact with the relative top of the first container, the first resilient member forces the upper locking portion into the locked position, securing the second container in the substantially flush contact.

9. The system of claim 8, wherein the first protrusion comprises a slanted edge to translate a downward force from the placing of the second container into a rotational force to pivot the upper locking portion into the unlocked position.

10. A method for securing a first container having an upper locking portion to a second container having a lower locking portion, the method comprising:
causing the upper locking portion to pivot from a locked position to an unlocked position;
positioning a relative bottom of the second container substantially flush with a relative top of the first container;
causing the upper locking portion to pivot to locked position; and
applying a force to the lower locking portion to cause the lower locking portion to pivot from a locked position to an unlocked position, the force being applied in a direction that is substantially perpendicular to and extending away from a plane defined by the substantially flush position of the first and second containers,
wherein:
in the locked position, the upper locking portion secures the second container to the first container,
in the unlocked position, the upper locking portion does not interface with the second container, and
the pivoting of the lower locking portion causes the lower locking portion to interface with the upper locking portion and to force the upper locking portion to pivot from the locked position to the unlocked position.

11. The method of claim 10, wherein:
the upper locking portion comprises:
a first body having a first protrusion extending laterally from the first body towards a relative center of the first container;
a first pivot structured to interface with a cavity of the first container; and
a first spring configured to bias the upper locking portion in the locked position, and
the lower locking portion comprises:
a second body having a surface and a second protrusion extending substantially parallel to a side of the second container;
a second pivot structured to pivotably couple the second body to the second container; and
a second spring configured to bias the lower locking portion in the locked position; and
the pivoting of the lower locking portion causes the second protrusion to abut the first body and cause the upper locking portion to pivot to the unlocked position.

12. The method of claim 11, wherein the first pivot is not fixed to the cavity.

13. The method of claim 11, wherein the upper locking portion further comprises:
a groove positioned in a side of the first body, the groove curved about an axis of rotation defined by the first pivot; and
a pin extending from the first container into the groove.

14. The method of claim 13, wherein the pin interacting with a first end of the groove defines the locked position, and the pin interacting with a second end of the groove defines the unlocked position.

15. The method of claim 11, wherein:
the upper locking portion is positioned on a relative top of the first container, and
the lower locking portion is positioned on a relative bottom of the second container.

16. The method of claim 15, wherein:
the upper locking portion is a first upper locking portion and the lower locking portion is a first lower locking portion,
the first container further comprises a second lower locking portion positioned on a relative bottom of the first container, the second lower locking portion identical to the first lower locking portion, and
the second container further comprises a second upper locking portion positioned on a relative top of the second container, the second upper locking portion identical to the first upper locking portion.

17. A system comprising a first container, the first container comprising:
a first upper portion comprising an upper locking portion including a first pivot structured to interface with a container; and
a first lower portion comprising a lower locking portion including a second pivot structured to interface with the container,
wherein the first pivot is sized and shaped to interface with a second lower portion of a second container, and
wherein the second pivot is sized and shaped to interface with a second upper portion of the second container.

18. The system of claim 17, wherein the upper locking portion further comprises:
a recess positioned in a side of the upper locking portion.

19. The system of claim 18, wherein the lower locking portion further comprises:
a protrusion, wherein the protrusion is complementary in size and shape to the recess.

20. The system of claim 19, wherein:
the recess receives the protrusion so that when interfacing, the upper locking portion rotates about the first pivot and the second locking portion rotates about the second pivot.

21. A system for securing a first container to a second container, the system comprising:
a locking portion on the first container, the locking portion comprising:
a body having a protrusion extending laterally from the body towards a relative center of the first container; and
an arm structured to float within a cavity of the first container and rotate about an axis, the axis defining a pivot point for the body about the cavity,
wherein:
the protrusion abuts the second container and restricts movement of the second container in a locked position, and
the body is configured to rotate about the cavity from the locked position to an unlocked position in which the protrusion is disengaged from the second container.

22. The system of claim 21, wherein the arm is not directly coupled to the cavity.

23. A method for securing a first container having a locking portion to a second container, the method comprising:
causing the locking portion to pivot from a locked position to an unlocked position;
positioning a relative bottom of the second container substantially flush with a relative top of the first container;
causing the locking portion to pivot to locked position; and
applying a force to the locking portion to cause the locking portion to pivot from the locked position to the unlocked position, the force being applied in a direction that is substantially perpendicular to and extending away from a plane defined by the substantially flush position of the first and second containers,
wherein:
in the locked position, the locking portion secures the second container to the first container, and
in the unlocked position, the locking portion does not interface with the second container.

24. The method of claim 23, wherein the locking portion is biased into the locked position by a resilient member.

25. The method of claim 24, wherein the applied force is directly opposite a biasing force from the resilient member.

26. The method of claim 23, wherein the locked portion is caused to pivot from the locked position to the unlocked position by the relative bottom of the second container interfacing with a slanted surface of the locking portion.
